(19) United States
(12) Patent Application Publication
(10) Pub. No.: US 2026/0135501 A1
(43) Pub. Date: May 14, 2026

(54) CONTROL METHOD FOR MULTI-TAP COMPATIBLE WITH FEWER TAPS AND BRUSHLESS DIRECT CURRENT MOTOR

(71) Applicant: ZHONGSHAN BROAD-OCEAN MOTOR CO., LTD., Zhongshan (CN)

(72) Inventors: Xiansheng ZHANG, Zhongshan (CN); Feilai Li, Zhongshan (CN); Hairong SUN, Zhongshan (CN)

(21) Appl. No.: 19/270,421

(22) Filed: Jul. 15, 2025

(30) Foreign Application Priority Data
Nov. 12, 2024 (CN) 2024116158907

(51) Int. Cl. H02P 21/18; H02P 21/20; H02P 27/08

(52) U.S. Cl. CPC H02P 21/18; H02P 21/20; H02P 27/08

(57) ABSTRACT

The present invention discloses a control method for multi-tap compatible with fewer taps and a brushless direct current motor. The method includes: presetting N default taps and M combined taps in a microprocessor, and setting preset values for each default tap and each combined tap, respectively, where one combined tap at least triggers one default tap; when detecting a default tap, running, by the microprocessor, a preset value corresponding to the default tap, and when the combined taps have a preset value of zero and the microprocessor detects a combined tap, running the combined tap, that is, triggering a composite tap and taking a maximum target value or a minimum target value from the taps to run, or when the combined taps have no preset value of zero and the microprocessor detects a combined tap, running the combined tap, and simultaneously triggering a preset value corresponding to the combined tap. Through processing of software logic, control of a motor with multi-tap compatible with fewer taps is achieved, and a problem in which shutdowns and logic error fault alarms occur when no preset values or preset values of zero are set for excess taps is avoided.

### RELATED APPLICATIONS

This application claims priority to Chinese Patent Application Ser. No. 2024116158907, filed Nov. 12, 2024, the disclosure of which is incorporated by reference in its entirety.

### FIELD OF THE DISCLOSURE

The present invention relates to the direct current motor control field, and in particular, to a control method for multi-tap compatible with fewer taps and a brushless direct current motor.

### BACKGROUND

Existing air conditioners all use motors to drive fans. Generally, multiple rotational speed taps are set for a motor to control different levels of output air volumes of the fan. The operation of multiple rotational speed taps relies on tap detection circuits in the motor controller which identify command requirements of the load.

Currently, the most common method is as follows: The motor controller sets several physical tap detection circuits, which receive control commands of the load and input signals into the microprocessor of the motor controller. The motor controller selects, based on the signals from the several tap detection circuits, one rotational speed tap to control the motor operation. Among the several physical tap detection circuits, only one physical tap detection circuit is connected to the signal source each time, while the others are all disconnected. However, motors for air conditioner load applications of existing air conditioner manufacturers and end-users generally evolve gradually from single-tap motors to dual-tap motors, five-tap motors, nine-tap motors, or motors with even more taps. During this upgrade process, newly applied multi-tap motors are required to be compatible with or cover the application scenarios of older motors with fewer taps. Therefore, when the multi-tap motors replace the motors with fewer taps, it is easy for excess taps to have no preset values or preset values of zero, causing shutdowns and logic error alarms.

### SUMMARY

The present invention overcomes the shortcomings of the prior art, and provides a control method for multi-tap compatible with fewer taps and a brushless direct current motor. Through processing of software logic, control of a motor with multi-tap compatible with fewer taps is achieved.

To achieve the above object, the present invention uses the following technical solutions:

A control method for multi-tap compatible with fewer taps, including:
S1. presetting N default taps and M combined taps in a microprocessor, and setting preset values for each default tap and each combined tap, respectively, where one combined tap at least triggers one default tap, and N and M are positive numbers;
S2. determining, by the microprocessor, whether at least one combined tap of the M combined taps has a preset value of zero;
S3. if yes, proceeding to S4 to enter an N-tap control mode; otherwise, proceeding to S5 to enter an N+M tap control mode;
S4. when detecting a default tap, running, by the microprocessor, a preset value corresponding to the default tap; when detecting a combined tap, running, by the microprocessor, the combined tap, that is, triggering a composite tap, comparing taps included in the composite tap, and taking a maximum target value or a minimum target value from the taps to run; and
S5. when detecting a default tap, running, by the microprocessor, a preset value corresponding to the default tap; when detecting a combined tap, running, by the microprocessor, the combined tap, and simultaneously triggering a preset value corresponding to the combined tap.

The control method for multi-tap compatible with fewer taps as described above, where in S1, one combined tap triggers two default taps.

The control method for multi-tap compatible with fewer taps as described above, where in S4, when the combined tap is detected, a maximum preset value of two default taps simultaneously triggered by the combined tap is run.

The control method for multi-tap compatible with fewer taps as described above, where in S4, when the combined tap is detected, a minimum preset value of two default taps simultaneously triggered by the combined tap is run.

The control method for multi-tap compatible with fewer taps as described above, further including N physical tap detection circuits, where an output end of each physical tap detection circuit is connected to an I/O port of the microprocessor, an input end of each physical tap detection circuit is connected to a single signal source, and one default tap activates one physical tap detection circuit.

The control method for multi-tap compatible with fewer taps as described above, further including a memory, where the default taps, preset values of the default taps, the combined taps, and preset values of the combined taps each are stored in the memory, and the microprocessor performs detection on the memory to read each tap and corresponding preset value information of each tap.

A brushless direct current motor, including a motor body and a motor controller, where the motor body includes an outer stator assembly and a rotor assembly, and the motor controller includes a microprocessor, an inverter circuit, N physical tap detection circuits, and a power supply part, where according to the control method for multi-tap compatible with fewer taps as described above, the microprocessor controls, based on a single signal input from a physical tap detection circuit, the motor body to run based on a corresponding preset value.

The brushless direct current motor according to claim 1, where the preset value is a target rotational speed value of the motor, a target torque value of the motor, or a target air volume value of the motor.

Beneficial effects of the present invention are as follows:

In the present invention, through the processing of software logic, it is ensured that new multi-tap motors can be compatible with the control logic of previous motors with fewer taps, regardless of whether various combined taps or single physical taps exist. This diversifies the application scenarios of motors with taps, facilitates the replacement of motors with fewer taps in the original system with multi-tap motors, and avoids a problem in which shutdowns and logic error fault alarms occur when no preset values or preset values of zero are set for excess taps.

### BRIEF DESCRIPTION OF THE DRAWINGS

FIG. 1 is a control flowchart of an embodiment of nine taps compatible with five taps according to the present invention.

FIG. 2 is a diagram of a physical tap detection circuit of an embodiment of five taps according to the present invention

### DETAILED DESCRIPTION

The technical solutions of the embodiments of the present invention will be clearly and completely described below with reference to the accompanying drawings.

It should be noted that all directional indications (such as up, down, left, right, front, back, etc.) in the embodiments of the present invention are only used to explain relative positional relationships, movements, and the like between various components in a specific posture (as shown in the accompanying drawings). If the specific posture changes, the directional indications will also change accordingly. Additionally, descriptions involving terms such as “preferred” and “less preferred” in the present invention are for illustrative purposes only and should not be construed as indicating or implying relative importance or implicitly specifying a quantity of the indicated technical features. Thus, features defined as “preferred” or “less preferred” may explicitly or implicitly include at least one such feature.

A control method for multi-tap compatible with fewer taps, including:
S1. presetting N default taps and M combined taps in a microprocessor, and setting preset values for each default tap and each combined tap, respectively, where one combined tap at least triggers one default tap, and N and M are positive numbers;
S2. determining, by the microprocessor, whether at least one combined tap of the M combined taps has a preset value of zero;
where preferably, in S1, one combined tap triggers two default taps;
S3. if yes, proceeding to S4 to enter an N-tap control mode; otherwise, proceeding to S5 to enter an N+M tap control mode;
S4. when detecting a default tap, running, by the microprocessor, a preset value corresponding to the default tap; when detecting a combined tap, running, by the microprocessor, the combined tap, that is, triggering a composite tap, comparing taps included in the composite tap, and taking a maximum target value or a minimum target value from the taps to run;
where preferably, in S4, when the combined tap is detected, a maximum preset value or a minimum preset value of two default taps simultaneously triggered by the combined tap is run; and
S5. when detecting a default tap, running, by the microprocessor, a preset value corresponding to the default tap; when detecting a combined tap, running, by the microprocessor, the combined tap, and simultaneously triggering a preset value corresponding to the combined tap.

In the present invention, N physical tap detection circuits are further included, where an output end of each physical tap detection circuit is connected to an I/O port of the microprocessor, an input end of each physical tap detection circuit is connected to a single signal source, and one default tap activates one physical tap detection circuit; and further includes a memory, where the default taps, preset values of the default taps, the combined taps, and preset values of the combined taps each are stored in the memory, and the microprocessor performs detection on the memory to read each tap and corresponding preset value information of each tap.

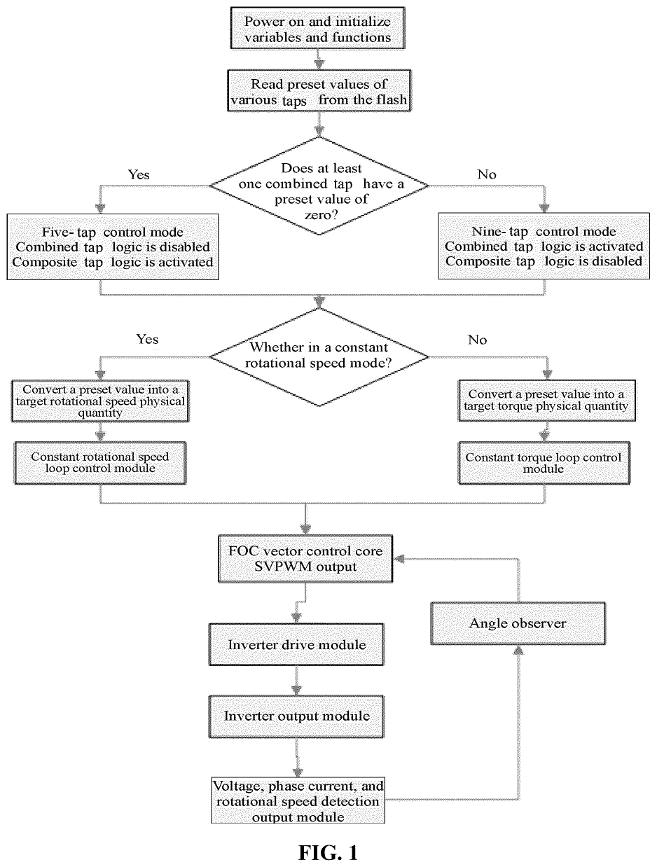

As shown in FIG. 1, the following uses the application of nine taps compatible with five taps as an example. The microprocessor enters a five-tap control mode, and sets that one combined tap triggers two default taps; and when a combined tap is detected, a maximum preset value of two default taps simultaneously triggered by the combined tap is run. The control logic is described as follows:
S1. Rotational speed values of various taps are prestored in a memory of a nine-tap motor, which are set as follows:
T1=400 rpm;
T2=500 rpm;
T3=600 rpm;
T4=700 rpm;
T5=800 rpm;
T6=900 rpm;
T7=0 rpm;
T8=1000 rpm; and
T9=0 rpm;
where T1 to T5 are default taps, and T6 to T9 are combined taps;
the combined tap T6 simultaneously activates the default taps T1 and T2 to form a composite tap;
the combined tap T7 simultaneously activates the default taps T1 and T3 to form a composite tap;
the combined tap T8 simultaneously activates the default taps T1 and T4 to form a composite tap; and
the combined tap T9 simultaneously activates the default taps T1 and T5 to form a composite tap;
S2. The microprocessor, after being powered on, reads the preset rotational speed values of various taps in the memory of the nine-tap motor, and determines whether at least one combined tap of the combined taps T6 to T9 has a preset rotational speed value of zero;
S3. Because the preset rotational speed values of the combined taps T7 and T9 are zero, the microprocessor enters the five-tap control mode. In this case, combined tap logic is disabled, and composite tap logic is activated;
S4. It is set that when the microprocessor detects any default tap of the default taps T1 to T5, a corresponding physical tap detection circuit inputs signals to the microprocessor, so that the microprocessor runs a preset rotational speed value corresponding to the default tap;
when the microprocessor detects the combined tap T6, physical tap detection circuits corresponding to the default taps T1 and T2 are simultaneously activated and input signals to the microprocessor, so that the microprocessor runs a maximum preset value of the default taps T1 and T2;
when the microprocessor detects the combined tap T7, physical tap detection circuits corresponding to the default taps T1 and T3 are simultaneously activated and input signals to the microprocessor, so that the microprocessor runs a maximum preset value of the default taps T1 and T3;
when the microprocessor detects the combined tap T8, physical tap detection circuits corresponding to the default taps T1 and T4 are simultaneously activated and input signals to the microprocessor, so that the microprocessor runs a maximum preset value of the default taps T1 and T4; and
when the microprocessor detects the combined tap T9, physical tap detection circuits corresponding to the default taps T1 and T5 are simultaneously activated and input signals to the microprocessor, so that the microprocessor runs a maximum preset value of the default taps T1 and T5.

Therefore, in this embodiment, when a user inputs the default tap T1, the microprocessor runs the preset rotational speed value of the default tap T1 of 400 rpm;
when the user inputs the default tap T2, the microprocessor runs the preset rotational speed value of the default tap T2 of 500 rpm;
when the user inputs the default tap T3, the microprocessor runs the preset rotational speed value of the default tap T3 of 600 rpm;
when the user inputs the default tap T4, the microprocessor runs the preset rotational speed value of the default tap T4 of 700 rpm;
when the user inputs the default tap T5, the microprocessor runs the preset rotational speed value of the default tap T5 of 800 rpm;
when the user inputs the combined tap T6, the microprocessor runs the maximum preset value of the default taps T1 and T2, that is, runs the preset rotational speed value of the default tap T2 of 500 rpm;
when the user inputs the combined tap T7, the microprocessor runs the maximum preset value of the default taps T1 and T3, that is, runs the preset rotational speed value of the default tap T3 of 600 rpm;
when the user inputs the combined tap T8, the microprocessor runs the maximum preset value of the default taps T1 and T4, that is, runs the preset rotational speed value of the default tap T4 of 700 rpm; and
when the user inputs the combined tap T9, the microprocessor runs the maximum preset value of the default taps T1 and T5, that is, runs the preset rotational speed value of the default tap T5 of 800 rpm.

As shown in FIG. 1, the following uses the application of nine taps compatible with five taps as an example. The microprocessor enters a nine-tap control mode, and sets that one combined tap triggers two default taps. The control logic is described as follows:
S1. Rotational speed values of various taps are prestored in a memory of a nine-tap motor, which are set as follows:

$$T 1 = 400 rpm ;$$

$$T 2 = 500 rpm ;$$

$$T 3 = 600 rpm ;$$

$$T 4 = 700 rpm ;$$

$$T 5 = 800 rpm ;$$

$$T 6 = 900 rpm ;$$

$$T 7 = 1000 rpm ;$$

$$T 8 = 1100 rpm ; and$$

$$T 9 = 1200 rpm ;$$

where T1 to T5 are default taps, and T6 to T9 are combined taps;
the combined tap T6 simultaneously activates the default taps T1 and T2;
the combined tap T7 simultaneously activates the default taps T1 and T3;
the combined tap T8 simultaneously activates the default taps T1 and T4; and
the combined tap T9 simultaneously activates the default taps T1 and T5;
S2. The microprocessor, after being powered on, reads the preset rotational speed values of various taps in the memory of the nine-tap motor, and determines whether at least one combined tap of the combined taps T6 to T9 has a preset rotational speed value of zero;
S3. Because the combined taps T7 to T9 have no preset rotational speed value of zero, the microprocessor enters the nine-tap control mode. In this case, combined tap logic is activated, and composite tap logic is disabled;
S4. It is set that when the microprocessor detects any default tap of the default taps T1 to T5, a corresponding physical tap detection circuit inputs signals to the microprocessor, so that the microprocessor runs a preset rotational speed value corresponding to the default tap;
when the microprocessor detects the combined tap T6, physical tap detection circuits corresponding to the default taps T1 and T2 are simultaneously activated and input signals to the microprocessor, so that the microprocessor runs a sum of the preset values of the default taps T1 and T2;
when the microprocessor detects the combined tap T7, physical tap detection circuits corresponding to the default taps T1 and T3 are simultaneously activated and input signals to the microprocessor, so that the microprocessor runs a sum of the preset values of the default taps T1 and T3;
when the microprocessor detects the combined tap T8, physical tap detection circuits corresponding to the default taps T1 and T4 are simultaneously activated and input signals to the microprocessor, so that the microprocessor runs a sum of the preset values of the default taps T1 and T4; and
when the microprocessor detects the combined tap T9, physical tap detection circuits corresponding to the default taps T1 and T5 are simultaneously activated and input signals to the microprocessor, so that the microprocessor runs a sum of the preset values of the default taps T1 and T5.

Therefore, in this embodiment, when a user inputs the default tap T1, the microprocessor runs the preset rotational speed value of the default tap T1 of 400 rpm;
when the user inputs the default tap T2, the microprocessor runs the preset rotational speed value of the default tap T2 of 500 rpm;
when the user inputs the default tap T3, the microprocessor runs the preset rotational speed value of the default tap T3 of 600 rpm;
when the user inputs the default tap T4, the microprocessor runs the preset rotational speed value of the default tap T4 of 700 rpm;
when the user inputs the default tap T5, the microprocessor runs the preset rotational speed value of the default tap T5 of 800 rpm;
when the user inputs the combined tap T6, the microprocessor runs the sum of the preset values of the default taps T1 and T2, that is, runs 400+500=900 rpm;
when the user inputs the combined tap T7, the microprocessor runs the sum of the preset values of the default taps T1 and T3, that is, runs 400+600=1000 rpm;
when the user inputs the combined tap T8, the microprocessor runs the sum of the preset values of the default taps T1 and T4, that is, runs 400+700=1100 rpm; and
when the user inputs the combined tap T9, the microprocessor runs the sum of the preset values of the default taps T1 and T5, that is, runs 400+800=1200 rpm.

In the present invention, a brushless direct current motor is provided, including a motor body and a motor controller, where the motor body includes an outer stator assembly and a rotor assembly, and the motor controller includes a microprocessor, an inverter circuit, A physical tap detection circuits, and a power supply part, where according to the control method for multi-tap compatible with fewer taps as described above, the microprocessor controls, based on a single signal input from a physical tap detection circuit, the motor body to run based on a corresponding preset value. The preset value is a target rotational speed value of the motor, a target torque value of the motor, or a target air volume value of the motor.

In the present invention, when entering either the five-tap control mode or the nine-tap control mode and detecting a single input signal from any physical tap detection circuit, the microprocessor runs a corresponding preset rotational speed value and determines whether it is in a constant rotational speed mode. If the microprocessor is in the constant rotational speed mode, the preset rotational speed value is converted into a target rotational speed physical quantity and sent to a constant rotational speed loop control module. If the microprocessor is not in the constant rotational speed mode, the preset rotational speed value is converted into a target torque physical quantity and sent to a constant torque loop control module. Then, the constant rotational speed loop control module or the constant torque loop control module outputs FOC vector control core SVPWM to an inverter drive module. The inverter drive module controls, based on the SVPWM, a voltage, phase current, and rotational speed detection output module to operate, and an angle observer adjusts the FOC vector control core SVPWM based on output information feedback from the voltage, phase current, and rotational speed detection output module, so that the motor operates with a constant rotational speed or a constant torque.

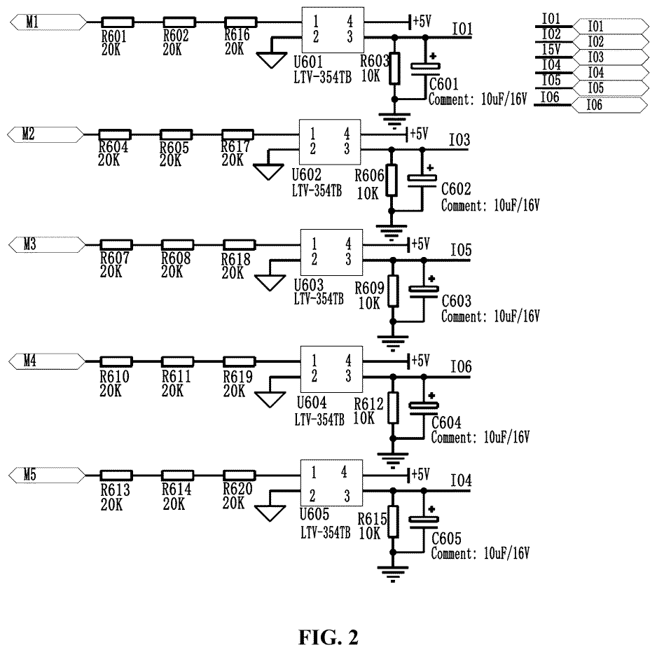

As shown in FIG. 2, each physical tap detection circuit is an optocoupler isolation circuit, including a first resistor, a second resistor, a third resistor, an optocoupler chip, a fourth resistor, and an electrolytic capacitor. During actual use, when triggered, a physical tap detection circuit connects to a signal source, and an output signal formed through the physical tap detection circuit from an input signal is a high-level signal; and upon disconnection, the output signal is a low-level signal. For example, when triggered, a physical tap detection circuit M1 connects to the signal source, an output signal IO1 formed through the physical tap detection circuit from an input signal M1 is a high-level signal, and is sent to the microprocessor; and upon disconnection, the output signal IO1 is a low-level signal. In the present invention, physical tap detection circuits M1 to M5 are in one-to-one correspondence with the default taps T1 to T5.

The above descriptions are merely preferred embodiments of the present invention and shall not be construed as limiting the patent scope of the present invention. Any equivalent structural modifications made under the inventive concept of the present invention by using the specification and the accompanying drawings of the present invention, whether directly or indirectly applied to other related technical fields, shall fall within the patent protection scope of the present invention.

1. A control method for multi-tap compatible with fewer taps, comprising:
S1. presetting N default taps and M combined taps in a microprocessor, and setting preset values for each default tap and each combined tap, respectively, wherein one combined tap at least triggers one default tap, and N and M are positive numbers;
S2. determining, by the microprocessor, whether at least one combined tap of the M combined taps has a preset value of zero;
S3. if yes, proceeding to S4 to enter an N-tap control mode; otherwise, proceeding to S5 to enter an N+M tap control mode;
S4. when detecting a default tap, running, by the microprocessor, a preset value corresponding to the default tap; when detecting a combined tap, running, by the microprocessor, the combined tap, that is, triggering a composite tap, comparing taps comprised in the composite tap, and taking a maximum target value or a minimum target value from the taps to run; and
S5. when detecting a default tap, running, by the microprocessor, a preset value corresponding to the default tap; when detecting a combined tap, running, by the microprocessor, the combined tap, and simultaneously triggering a preset value corresponding to the combined tap.

2. The control method for multi-tap compatible with fewer taps according to claim 1, wherein in S1, one combined tap triggers two default taps.

3. The control method for multi-tap compatible with fewer taps according to claim 2, wherein in S4, when the combined tap is detected, a maximum preset value of two default taps simultaneously triggered by the combined tap is run.

4. The control method for multi-tap compatible with fewer taps according to claim 2, wherein in S4, when the combined tap is detected, a minimum preset value of two default taps simultaneously triggered by the combined tap is run.

5. The control method for multi-tap compatible with fewer taps according to claim 1, further comprising N physical tap detection circuits, wherein an output end of each physical tap detection circuit is connected to an I/O port of the microprocessor, an input end of each physical tap detection circuit is connected to a single signal source, and one default tap activates one physical tap detection circuit.

6. The control method for multi-tap compatible with fewer taps according to claim 1, further comprising a memory, wherein the default taps, preset values of the default taps, the combined taps, and preset values of the combined taps each are stored in the memory, and the microprocessor performs detection on the memory to read each tap and corresponding preset value information of each tap.

7. A brushless direct current motor, comprising a motor body and a motor controller, wherein the motor body comprises an outer stator assembly and a rotor assembly, and the motor controller comprises a microprocessor, an inverter circuit, N physical tap detection circuits, and a power supply part, wherein according to the control method for multi-tap compatible with fewer taps according to claim 1, the microprocessor controls, based on a single signal input from a physical tap detection circuit, the motor body to run based on a corresponding preset value.

8. The brushless direct current motor according to claim 7, wherein the preset value is a target rotational speed value of the motor, a target torque value of the motor, or a target air volume value of the motor.
